(19) United States
(12) Patent Application Publication
(10) Pub. No.: US 2009/0065471 A1
(43) Pub. Date: Mar. 12, 2009

(54) MICRO-NOZZLE, NANO-NOZZLE, MANUFACTURING METHODS THEREFOR, APPLICATIONS THEREFOR

(76) Inventor: Sadeg M. Faris, Pleasantville, NY (US)

Correspondence Address: REVEO, INC., 6 Skyline Drive, Hawthorne, NY, 10523, US

(21) Appl. No.: 10/775,999

(22) Filed: Feb. 10, 2004

Related U.S. Application Data
(60) Provisional application No. 60/446,296, filed on Feb. 10, 2003.

(51) Int. Cl. B32B 1/08; B44C 1/22

(52) U.S. Cl. 216/10; 216/33; 216/58; 216/83

(57) ABSTRACT

A nozzle structure is provided comprising a monolithic body having an array of nozzles. The nozzles having openings with sectional openings having heights of about 100 nm or less. The nozzles are generally associated with one or more well structures.

### CROSS-REFERENCE TO RELATED APPLICATIONS

This application claims the benefit under 35 U.S.C. §119(e) of U.S. Provisional Patent Application Ser. No. 60/446,296 filed on Feb. 10, 2003, entitled “Micro-Nozzle, Nano-Nozzle, Manufacturing Methods Therefor, Applications Therefore, Including Nanolithography and Ultra Fast Real Time DNA Sequencing,” which is herein incorporated by reference.

### FIELD OF THE INVENTION

The present invention relates to micro-nozzles and nano-nozzles, and methods of manufacturing micro-nozzles and nano-nozzles.

### BACKGROUND INFORMATION

Understanding and harnessing properties of nanotechnology has and will continue to result in 21st Century breakthroughs. Products such as nano-scale computing devices, nanotechnology based fibers stronger than steel, and advanced biochemical sensors are just a few of the astounding applications of nanotechnology.

One limitation in nanotechnology is processing devices used to handle, dispense, detect, or otherwise manipulate nanoparticles. While nozzles are known for applications such as inkjet printing and other deposition processes, nano-scale nozzles are generally unknown.

Thus, there remains a need in the art for improved sub-micron and nanoscale nozzles, and efficient and reliable methods of manufacturing sub-micron and nanoscale nozzles.

### SUMMARY OF THE INVENTION

The above-discussed and other problems and deficiencies of the prior art are overcome or alleviated by the several methods and apparatus of the present invention for micro and nano nozzles. A nozzle structure is provided comprising a monolithic body having an array of nozzles. The nozzles having openings with sectional openings having heights of about 100 nm or less. The nozzles are generally associated with one or more well structures.

Applications of the herein described nozzle include, but are not limited to, nanolithography, protein and DNA sequencing, and nano-chemistry, including synthesis and analysis.

The above-discussed and other features and advantages of the present invention will be appreciated and understood by those skilled in the art from the following detailed description and drawings.

### BRIEF DESCRIPTION OF THE DRAWINGS

FIG. 1 shows a portion of a device having a plurality of arrays of nozzles;

FIG. 2 depicts a starting multiple layered substrate used in certain embodiments herein;

FIGS. 3A-B show plural devices formed on a wafer to be formed into nozzles;

FIGS. 3C-D and 4 show details of the devices;

FIGS. 5A-B show a processing step to apply a layer to the device;

FIG. 6 shows removal of the device layer from a substrate;

FIG. 7 shows stacking of plural devices (or device layers);

FIG. 8 shows cut lines for forming nozzles from the stack of devices;

FIGS. 9-11 show an embodiment of one method of forming nozzle openings;

FIGS. 12-13 show another embodiment of one method of forming nozzle openings;

FIGS. 14-15 show another embodiment of one method of forming nozzle openings;

FIGS. 16-17 show a stack of nozzles with spacer layers therebetween;

FIG. 18 shows an enlarged view of a section of a nozzle;

FIG. 19 shows an enlarged view of a section of a nozzle detailing a grind stop;

FIG. 20A shows an enlarged cross section of stacked layers used to form the micro and nano nozzles;

FIG. 20B shows a front view of a nozzle;

FIG. 21 is another view of the nozzle depicting possible regions for electrodes or other nozzle features;

FIGS. 22A-D show an exemplary method of making nozzles with openings having various conductors (e.g., serving as electrodes) thereabout;

FIGS. 23A-C show an exemplary method of making nozzles with sub-layers;

FIGS. 24A-D show one exemplary array of nozzles;

FIGS. 25A-D show another exemplary array of nozzles;

FIGS. 26A-D show a further example of an array of nozzles;

FIGS. 27A-D show another example of an array of nozzles;

FIGS. 28A-B show a lithography application of the herein nozzles;

FIGS. 29A-B show another lithography application of the herein nozzles;

FIG. 30 is an overview of a sequencing application of the herein nozzles;

FIG. 31 shows arrays of the herein nozzles;

FIG. 32 shows an ultra fast DNA sequencing system;

FIG. 33 is a schematic of major components of the ultra-fast DNA sequencing system;

FIG. 34 is a top view of the ultra-fast DNA sequencing system;

FIGS. 35A-B detail each channel of the sequencing system;

FIG. 36 shows section views of the sequencing process;

FIG. 37 shows detailed views of hybridization events;

FIG. 38 shows all possible 16 combinations of A,T,G and C for sequencing;

FIG. 39 shows a reference position and precision nanometer metrology prove and system; and

FIG. 40 shows stepped motion of a strand to be sequenced relative to the probe of FIG. 39.

### DETAILED DESCRIPTION OF THE ILLUSTRATIVE EMBODIMENTS

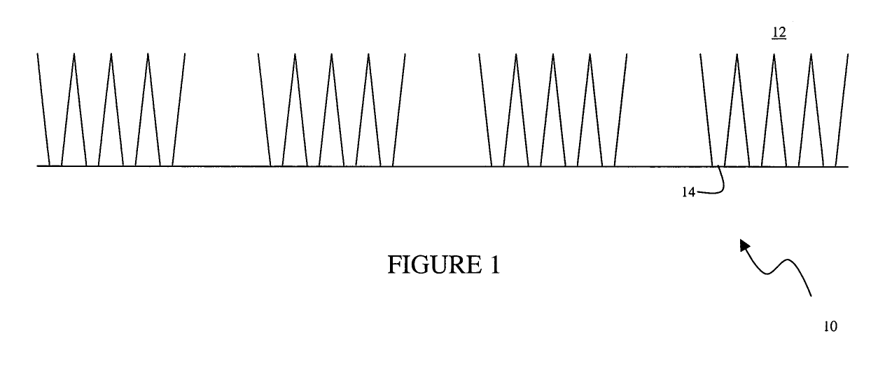

Herein disclosed are nano-nozzles and methods of manufacturing nano-nozzles. With the disclosed methods, it is possible to create nozzles with opening dimensions on the order of nanometers. Further, it is possible to make such nozzles in arrays with exact spacing therebetween. Such features enable molecular level dispersion, precise material deposition, molecular level detection, and other nano-scale processes. Referring to FIG. 1, a portion of a device 10 having a plurality of arrays 12 of nozzles 14 is depicted. Note that the dimensions of such nozzles may be on the order of a few nanometers (e.g., 5 nm) or greater, depending on the desired application. Further, the arrays may be spaced apart by 10s of nanometers to several micros apart.

The present method of manufacturing nozzles may be enhanced with the use of Applicant's multi-layered manufacturing methods, as described in U.S. Non-provisional application Ser. Nos. 09/950,909, filed Sep. 12, 2001 entitled “Thin films and Production Methods Thereof”; 10/222,439, filed Aug. 15, 2002 entitled “Mems And Method Of Manufacturing Mems”; 10/017,186 filed Dec. 7, 2001 entitled “Device And Method For Handling Fragile Objects, And Manufacturing Method Thereof”; and PCT Application Serial No. PCT/US03/37304 filed Nov. 20, 2003 and entitled “Three Dimensional Device Assembly and Production Methods Thereof”; all of which are incorporated by reference herein. However, other types of semiconductor and/or thin film processing may be employed.

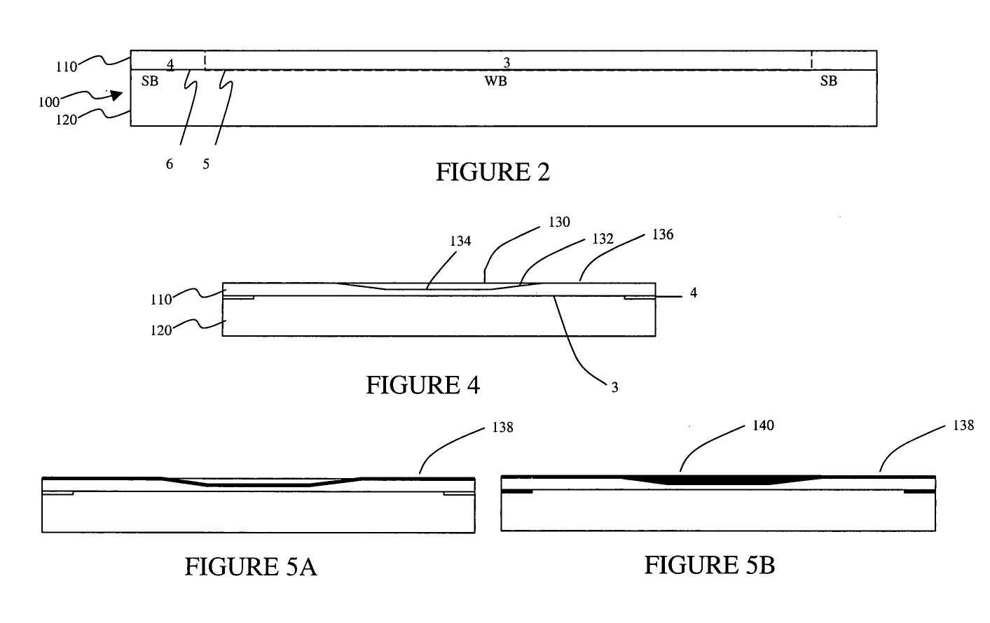

Referring to FIG. 2, a starting multiple layered substrate 100 is shown. The substrate 100 may be, in certain preferred embodiments, a wafer for processing thousands or even millions of nozzle arrays.

The multiple layered substrate 100 includes a first device layer 110 selectively bonded to a second substrate layer 120, having strongly bonded regions 3 and weakly bonded regions 4. Using the techniques described in the above-mentioned patent applications, or other suitable wafer processing and handling techniques, the first layer 110, intended for having one or more useful structures processed therein or therein, may readily be removed from the second substrate layer 120 (which serves as mechanical support during device processing) with little or no damage to the structure(s) formed (including wells or other subtractions to the layer 110) in or on the device layer 110.

Layers 110 and 120 may be the same or different materials, and may include materials including, but not limited to, plastics (e.g., polycarbonate), insulators, semiconductor, metal conductors, monocrystalline, amorphous, noncrystalline, biological (e.g., DNA based films) or a combination comprising at least one of the foregoing various types of materials. For example, specific types of materials include silicon (e.g., monocrystalline, polycrystalline, noncrystalline, polysilicon, and derivatives such as Si3N4, SiC, SiO2), GaAs, InP, CdSe, CdTe, SiGe, GaAsP, GaN, SiC, GaAlAs, InAs, AlGaSb, InGaAs, ZnS, AlN, TiN, other group IIIA-VA materials, group IIB materials, group VIA materials, sapphire, quartz (crystal or glass), diamond, silica and/or silicate based material, or any combination comprising at least one of the foregoing materials. Of course, processing of other types of materials may benefit from the process described herein to provide multiple layer substrates 100 of desired composition. Preferred materials which are particularly suitable for the herein described methods include semiconductor material (e.g., silicon) as layer 110, and semiconductor material (e.g., silicon) as layer 120. Other combinations include, but are not limited to; semiconductor (layer 110) on glass (layer 120); semiconductor (layer 110) on silicon carbide (layer 120); semiconductor (layer 110) on sapphire (layer 120); GaN (layer 110) on sapphire (layer 120); GaN (layer 110) on glass (layer 120); GaN (layer 110) on silicon carbide (layer 120); plastic (layer 110) on plastic (layer 120), wherein layers 110 and 120 may be the same or different plastics; and plastic (layer 110) on glass (layer 120).

Layers 110 and 120 may be derived from various sources, including wafers or fluid material deposited to form films and/or substrate structures. Where the starting material is in the form of a wafer, any conventional process may be used to derive layers 110 and/or 120. For example, layer 120 may consist of a wafer, and layer 110 may comprise a portion of the same or different wafer. The portion of the wafer constituting layer 110 may be derived from mechanical thinning (e.g., mechanical grinding, cutting, polishing; chemical-mechanical polishing; polish-stop; or combinations including at least one of the foregoing), cleavage propagation, ion implantation followed by mechanical separation (e.g., cleavage propagation, normal to the plane of structure 100, parallel to the plane of structure 100, in a peeling direction, or a combination thereof), ion implantation followed by heat, light, and/or pressure induced layer splitting), chemical etching, or the like. Further, either or both layers 110 and 120 may be deposited or grown, for example by chemical vapor deposition, epitaxial growth methods, or the like.

An important benefit of the instant method and resulting multiple layer substrate 100, or thin film (e.g., layer 110) derived from the multiple layer substrate 100 is that the structures are formed in or upon the weak bond regions 3. This substantially minimizes or eliminates likelihood of damage to the useful structures when the layer 110 is removed from layer 120. The debonding step generally requires intrusion (e.g., with ion implantation), force application, or other techniques required to debond layers 110 and 120. Since, in certain embodiments, the structures are in or upon regions 3 that do not need local intrusion, force application, or other process steps that may damage, reparably or irreparable, the structures, the layer 110 may be removed, and structures derived therefrom, without subsequent processing to repair the structures. The strong bond regions 4 generally not have structures thereon, therefore these regions 4 may be subjected to intrusion or force without damage to the structures.

The layer 110 may be removed as a self supported film or a supported film. For example, handles are commonly employed for attachment to layer 110 such that layer 110 may be removed from layer 120, and remain supported by the handle. Generally, the handle may be used to subsequently place the film or a portion thereof (e.g., having one or more useful structures) on an intended substrate, another processed film, or alternatively remain on the handle.

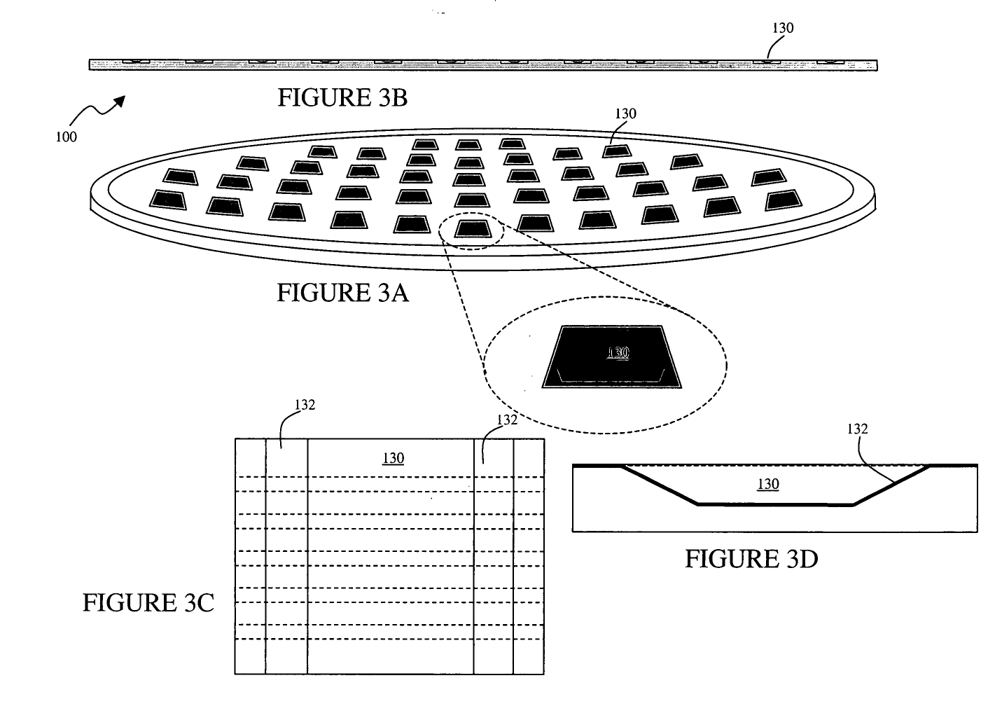

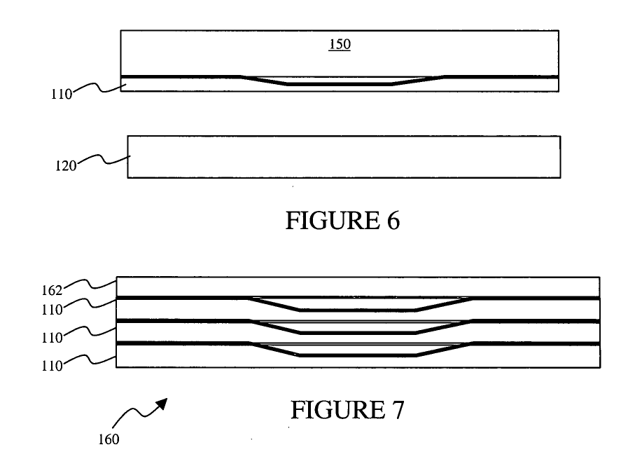

Referring now to FIGS. 3A and 3B, top isometric and sectional views, respectively, are provided of a selectively bonded substrate 100 having a plurality of wells 130 formed in the weakly bonded regions of the selectively bonded substrate 100. Note that the pattern of weak bond regions and strong bond regions may vary, as described in aforementioned U.S. Ser. No. 09/950,909 and PCT/US03/37304. However, it is preferred that all of the wells are formed at the weak bond regions of the device layer 110 and supported during processing by the support layer 120.

FIGS. 3C and 3D show plan and sectional views, respectively, of a single well 130 formed in the device layer 110 described above. Referring to FIG. 3C, the intersecting region between the dashed lines and the walls 132 of the wells 130 shows regions wherein nozzles 14 (as depicted in FIG. 1) may be processed in certain embodiments, as described hereinafter. In other embodiments, there may be only one intended region for processing nozzles (e.g., on the left or right sides as shown in FIGS. 3C and 3D).

In further embodiments, the wells may be formed only at the intended nozzle region, e.g., resembling grooves having the thickness shown by the dashed lines.

Referring also to FIG. 4, the etched well 130 generally has angular walls 132, the function of which will be readily apparent. Further, the center recessed portion 134 of the etched well will become part of a reservoir of the nozzles. At the top surface of the device layer 110 adjacent the outer ends of the angular walls 132 are plateau regions, which ultimately may be part of the inside wall of the nozzles as described herein.

The width (i.e., the y direction as shown in FIGS. 9-11) of the nozzles 14 may be the same or different from the width of the wells. In certain embodiments, it may be desirable to provide wells having widths larger than that of the nozzle to increase the material capacity of the well while maintaining the nozzle dimensions as small as possible.

Referring now to FIG. 4, a layer 110 (e.g., having thickness on the order of 10-100 nm for nano-nozzles used in applications where nozzle tips of a few nanometers are desired) is selectively bonded to a support layer 120 as described with respect to FIG. 2 and in aforementioned U.S. Ser. No. 09/950,909 and PCT/US03/37304. A region of reservoir 130 is etched away or otherwise removed from a region of the device layer in the weak bond region 3. Suitable nano-scale material subtraction methods may be used.

Referring now to FIG. 5A, a layer 138 (e.g., 5-10 nm) of material, preferably material that is easily removable by etching or other subtractive methods, is deposited on the wafer. This material may be conductive, such as copper, silicon oxide, aluminum, or other suitable materials. This space will later become the opening for the nozzle.

Referring to FIG. 5B, a fill 140 may optionally be incorporated, also of easily removable material in certain embodiments. The material optionally used to fill the wells during processing and stacking may be the same or different from the material used at the plateaus (that will form nozzle walls).

Since the device layer including the etched well having suitable material deposited thereon is generally positioned over the weak bond region 3 of the multiple layered substrate 100, the device layer 110 may readily be removed form the support layer 120. For example, the strong bond regions 4 may be etched away by through etching (e.g., normal to the surface through the thickness of the device layer in the vicinity of the strong bond region), edge etching (parallel to the surface of the layers), ion implantation (preferably with suitable masking of the etched well and deposited material to form the nozzle, or by selective ion implantation), or other known techniques. Since the above techniques are generally performed at the strong bond regions 4 only, the etched well and material deposited in the weak bond regions 3 are easily released form the substrate, as schematically shown in FIG. 5, for example with a handler 150.

Referring now to FIG. 7, several layers 110 including etched wells 130 having material deposited 138 thereon (and optionally fill 140) may be stacked to form a structure 160. The structure 160 may further include a solid layer 162, e.g., to form a wall for the top-most nozzle as shown in FIG. 7. Although in certain embodiments precise alignment may be desired at this point, certain embodiments may use relaxed alignment standards at this point, as will be apparent.

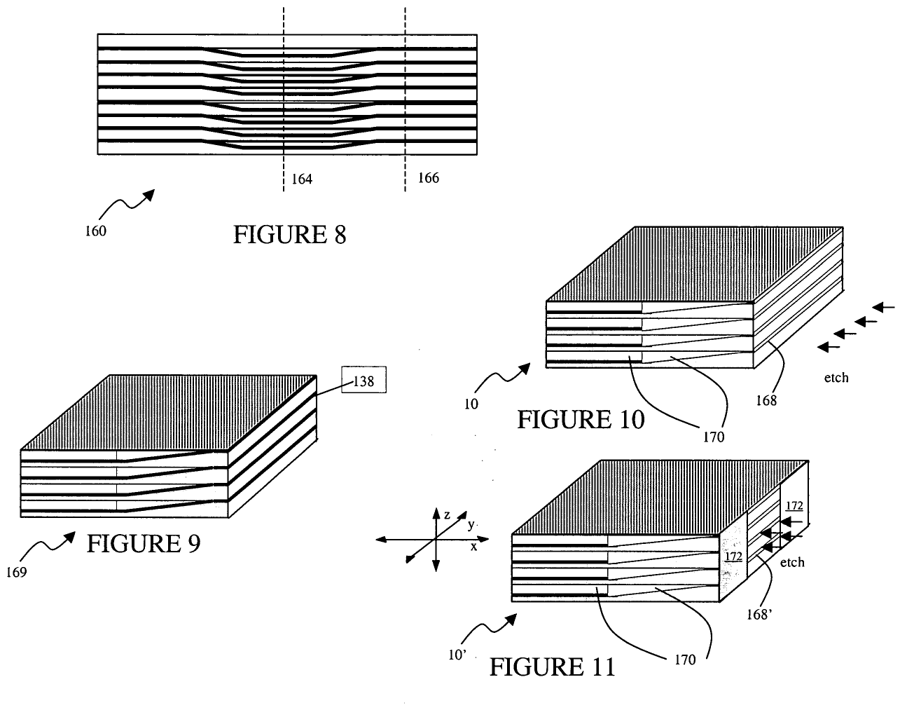

As shown in FIG. 8, the wafer stack 160 can now be sliced in the middle along the line 164, creating two portions with exposed reservoirs. From the opposing side, these devices can also be sliced along the line 166. The end may be grinded and polished until it is very close to the etched away reservoir, but no less than the desired nozzle length.

Referring now to FIGS. 9 and 10, the deposited material 138 may be etched away, exposing an etched channel 168 (e.g., 5 nm opening when the material deposition layer is 5 nm). A material reservoir 170 (or region 170 for other purposes, depending on the desired use of the nozzle structure) remains behind the opening 168. Each etched channel 168 is generally spaced apart by approximately the thickness of the device layer 110. Thus, a nozzle device 10 having plural openings 168 each associated with regions 170 is provided.

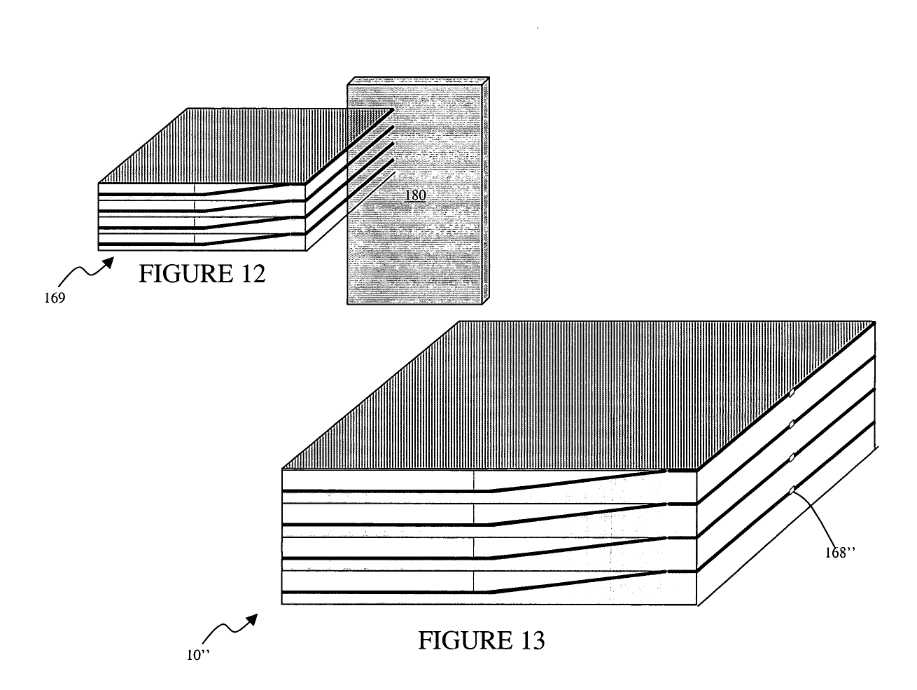

Alternatively, and referring to FIG. 11, to form an opening less than the width of the entire edge, the outside portions may be masked 172 prior to etching the deposited material 138 to form openings 168′. Thus, a nozzle device 10′ having plural openings 168′ is provided.

In a further embodiment, and referring now to FIGS. 12 and 13, a nozzle device 180 (e.g., as describe herein), of a single layer, may be rotated approximately 90° with respect to the stack of layers 160 having layers 138 deposited therein at the locations of the nozzles. Etchant may be filled in the reservoir of the rotated nozzle structure 180, and the openings 182 of the nozzles may be formed. Using this technique, it is possible to create nozzles having approximately the same width and height (e.g., 5-10 nm by 5-10 nm). Thus, a nozzle device 10″ having plural openings 168″ is provided.

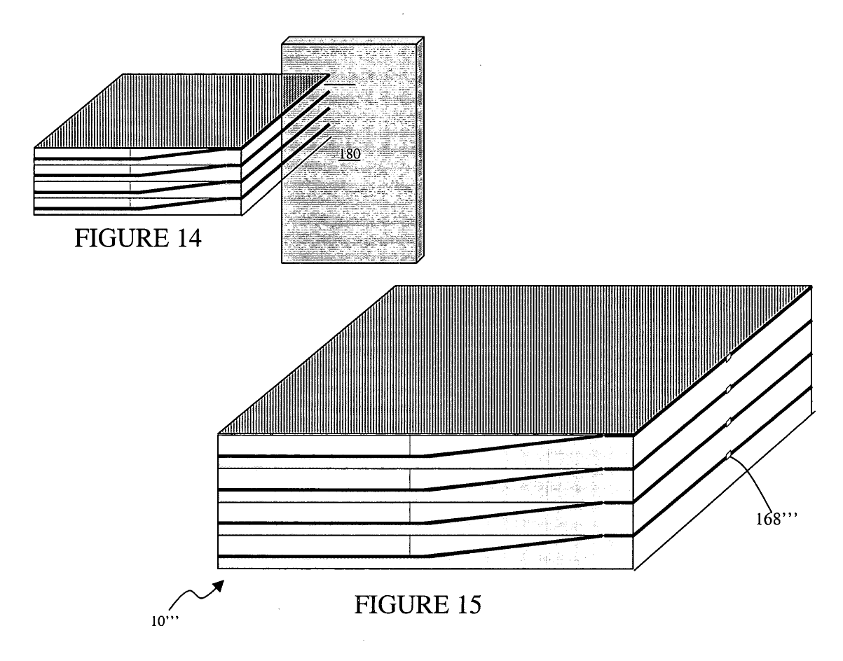

Referring now to FIGS. 14 and 15, another embodiment of a method of forming very small width nozzle diameters. As described with reference to FIGS. 9 and 10, the deposited material between layers may be etched away, exposing an etched channel (e.g., 5-10 nm high when the material deposition layer is 5-10 nm) spaced apart by approximately the thickness of the device layer.

These etched channels 168 may then be filled with an etchable material. For example, a nozzle device 180 as describe herein, of a single layer, may be rotated approximately 90° with respect to the stack of layers having material etched away at the locations of the nozzles. An etchable material may be filled in the reservoir of the rotated nozzle structure, which is filled at the regions where the nozzles on the stack of layers are to be formed. The surrounding areas between the layers are then filled with a plug material. Then the etchable material in the nozzle region is etched away, exposing the nozzles 168′″. Using this technique, it is possible to create nozzles having approximately the same width and height (e.g., 5-10 nm by 5-10 nm). Thus, a nozzle device 10′″ having plural openings 168′″ is provided.

Note this etchable material should be selectively removable by an etchant (e.g., not removing the bulk material).

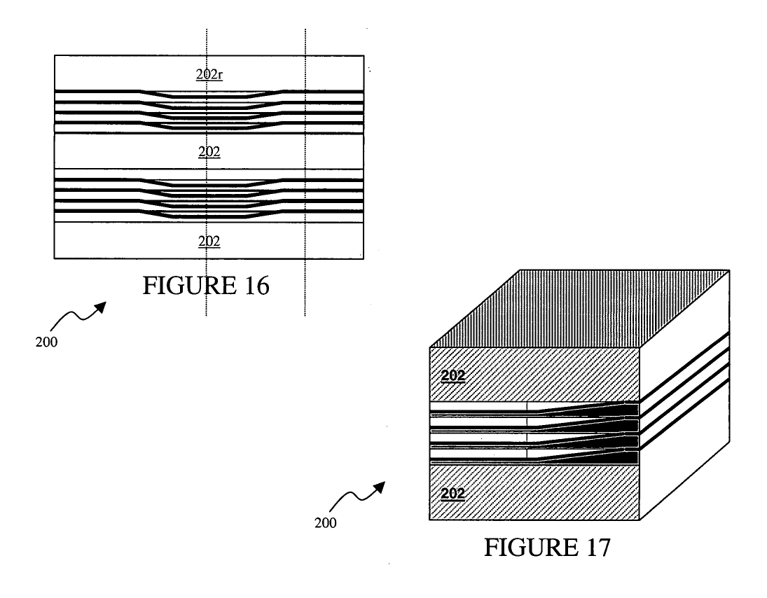

Referring now to FIGS. 16 and 17, a nozzle array 200 of the present invention is shown. Therein, one or more spacer layers 202 may be positioned between a desired number of to-be-formed channels, e.g., during stacking of the well structures.

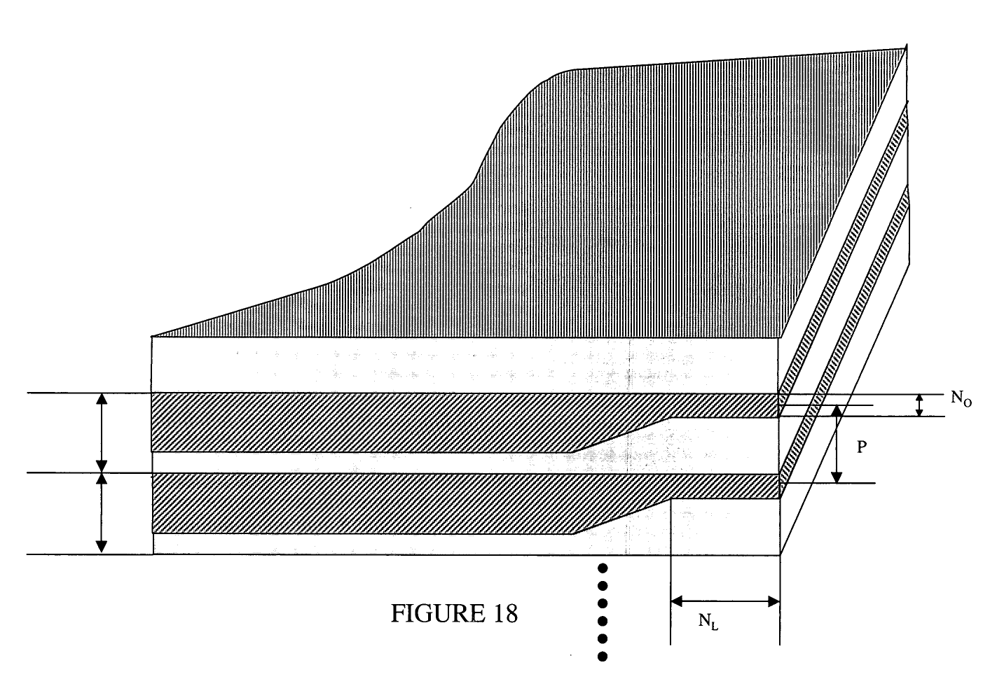

Referring to FIG. 18, an enlarged cross section of stacked layers 110 used to form the micro and nano nozzles having wells and tip portions as described herein, cut to desired tip length, is shown. The layers 138 have been processed to form the wells 130 and nozzle tip regions generally by deposition of a layer 138 of material capable of being selectively removed (e.g., etched) therein (the well) and thereon (the shelf at the top of the well), as described herein. The materials capable of being selectively removed for the plateau and/or the well may be the same or different. The wells and plateaus have various dimensions that will characterize the nozzle array ultimately formed. The nozzle has a tip length N_{L}, a tip opening height N_{O}, and a period P.

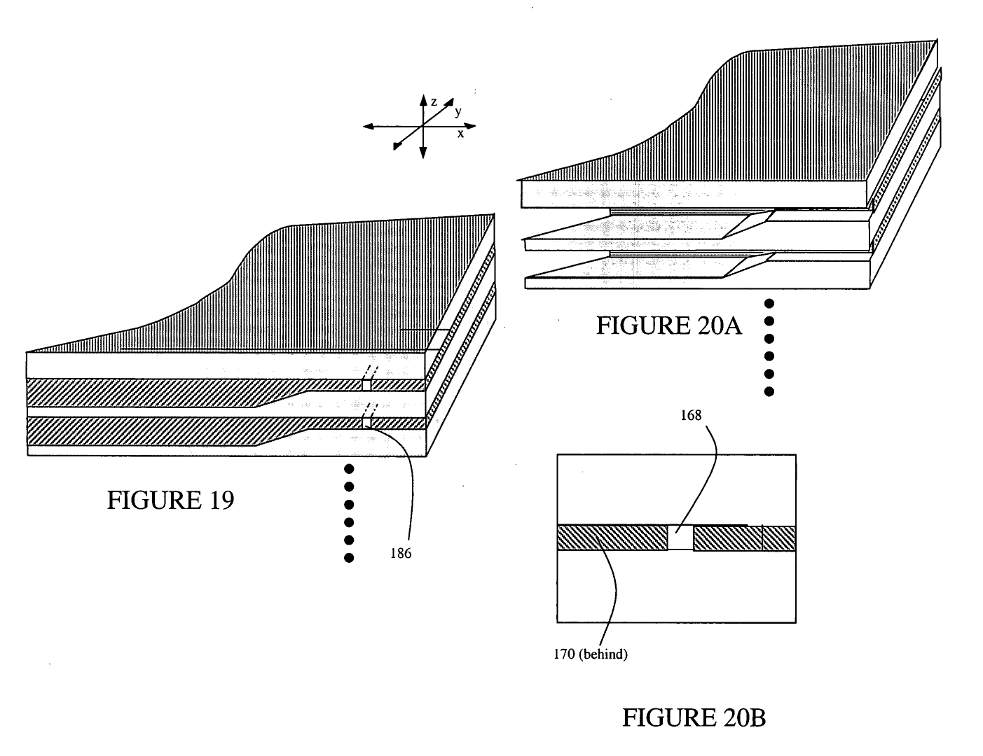

Referring to FIG. 19, an enlarged cross section of stacked layers used to form the micro and nano nozzles herein is shown, detailing grind stops 186 provided to enhance the ability to control the nozzle length N_{L}. In certain embodiments, it is desirable to minimize the nozzle length. A grind stop 186 is provided proximate the desired nozzle length. The grind stop may be provided during processing of the wells on the device layer. Further, the grind stops may further serve as alignment marks, e.g., as described in aforementioned PCT/US03/37304.

Referring to FIGS. 20A and 20B, an enlarged cross section of stacked layers used to form the micro and nano nozzles, and a front view of the nozzle, respectively, are shown. Note that in certain embodiments, the well 170 has a width (y direction) greater than that of the nozzle tip 168.

Note that in any of the herein described nozzles and nozzle arrays, associated structures may be provided. For example, in certain embodiments, one or more electrodes may be provided to facilitate material discharge, detection capabilities, etc. Further, one or more processors, micro or nano fluidic devices, micro or nano electromechanical devices, or any combination including the foregoing devices may be incorporated in a nozzle device. In certain preferred embodiments, electrodes are provided at the nozzle openings and/or wells, and an electrode controller and/or a microfluidic device (e.g., to feed or remove material from the nozzles) is associated with an array of nozzles.

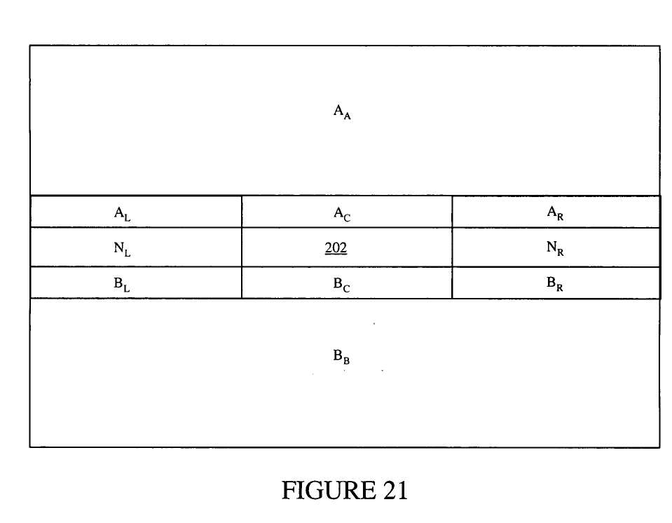

Referring now to FIG. 21, an enlarged view of a nozzle structure 200 is provided, viewing a nozzle opening 202. Nozzle opening 202 is generally positioned on a nozzle layer “N” between a top portion “A” and a bottom portion “B” (although top and bottom are considered to be relevant for the purpose of description herein only). To describe various embodiments of possible configurations, sections N, A and B have been divided into descriptive sections. These descriptive sections may be actual discrete regions of different material, or in certain embodiments multiple descriptive sections may be of the same material and thus actually a uniform region, as will be apparent from the various embodiments herein.

A_{A} and B_{B} may be the same or different materials, such as insulator or semiconductor materials to provide the structure of the nozzle 200, electrically insulate the nozzle openings from one another, fluidly seal the openings from one another, or other functionality.

In certain embodiments, the descriptive sections A_{L}, A_{C}, A_{R}, N_{L}, N_{R}, B_{L}, B_{C} and B_{R} are all of the same materials as A_{A} and B_{B}.

Any combination of A_{L}, A_{C}, A_{R}, N_{L}, N_{R}, B_{L}, B_{C} and/or B_{R} may be provided in the form of conductors. For example, referring back to FIG. 11, upon removal of the mask after etching the nozzle opening, a structure may be provided having A_{L}, A_{C}, A_{R}, B_{L}, B_{C} and B_{R} of the same materials as A_{A} and B_{B}, and N_{L}, N_{R} of conductive material.

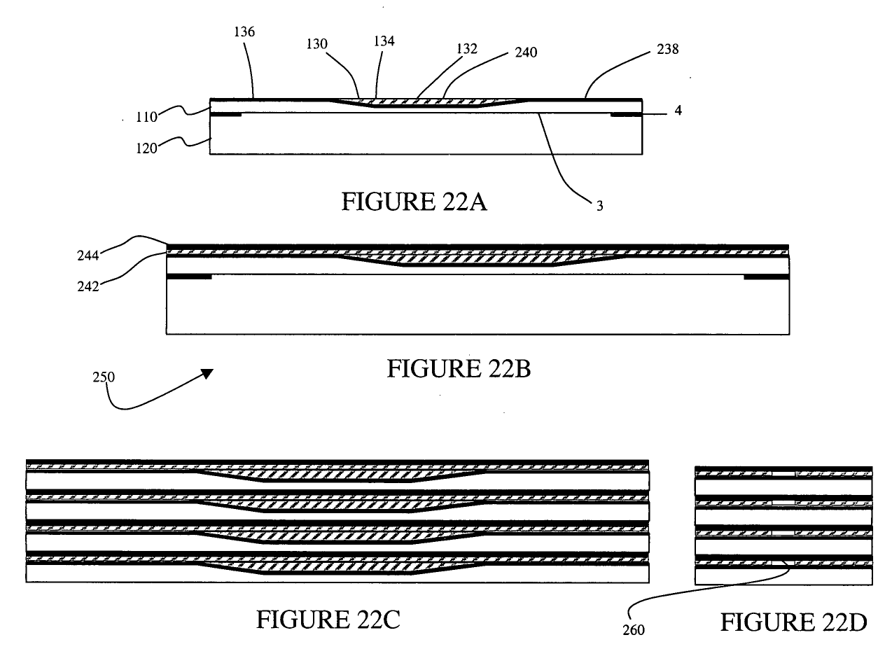

Further, and referring now to FIGS. 22A-D, an exemplary method of making nozzles with openings having various conductors (e.g., serving as electrodes) thereabout is depicted. FIG. 22A shows a starting section of a multiple layer substrate with layers 110 and 120 as described hereinabove. An etched well 130 generally has angular walls 132 and a center recessed portion 134. Plateau regions 136 form the opening walls or supports.

A layer 238 (e.g., 5-10 nm) of conductive material is deposited on the wafer. A removable fill material 240 may be provided in the well to facilitate layering. Referring to FIG. 22B, a removable fill layer 242 is provided on the surface having the conductive layer 238 and the optionally fill material 240. In this embodiment, the nozzle will be formed at the fill layer 242. Further, a conductive layer 244 is deposited or layered on the fill layer 242, forming a nozzle sub-structure 250.

Referring now to FIG. 22C, a plurality of nozzle sub-structures 250 are aligned and stacked (e.g., as described above with respect to FIG. 7). Referring to FIG. 22D, nozzle openings 260 may be formed, e.g., according to one of the methods described above with respect to FIGS. 9-15, or other lithography or oxidation methods. The resulting structure may be one wherein AL, AC, AR, BL, BC and BR of conductive materials and NL, NR are of insulative material.

Further, one or more pairs of opposite descriptive sections may be conductive (e.g., electrodes), thereby enabling creation of fields across the nozzle opening. For example, NL and NR, AC and BC, AL and BR, AR and BL, AL, AR and BL, BR may all be electrode pairs to provide any desired functionality. Additionally, one or more conductive electrodes may be within the well regions, e.g., to provide electromotive forces to move materials.

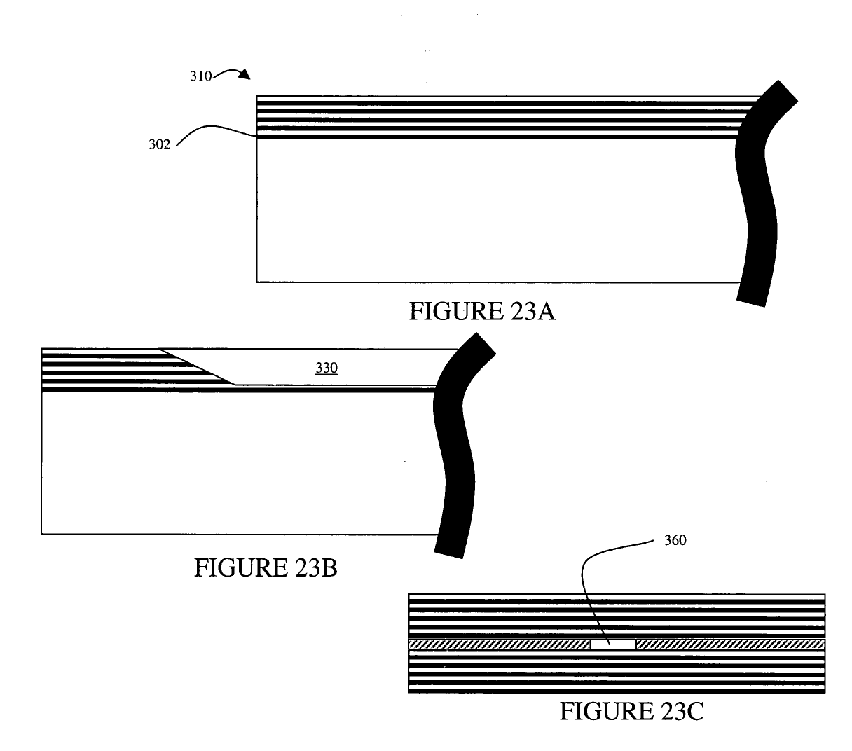

Referring now to FIGS. 23A-C, an example of a method of manufacturing the herein described nozzles is shown whereby a plurality of sub-layers 302 form each layer 310. Wells 330 are processed through the layer 310 as shown in FIG. 23B. FIG. 23C shows nozzle openings 360 having plural sublayers 302 therearound. These sub-layers may be very useful, for example, where precise metrology is desired.

For example, in certain embodiments, the sub-layers 302 are formed to very precise tolerances, e.g., having thicknesses on the order of 0.5 to about 5 nanometers. When these sub-layers 302 are formed of differing materials (e.g., alternating between insulator and semiconductor, semiconductor and conductor, or conductor and insulator), precise step motion may be enabled in the nozzle structures based on known dimensions of the nozzle sub-layers.

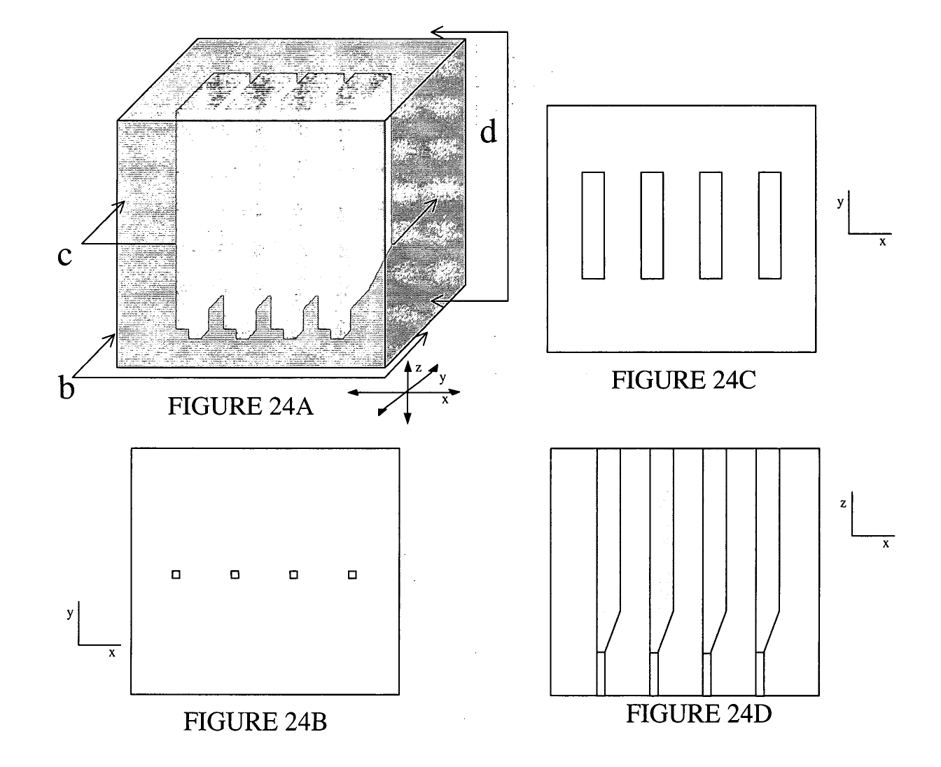

FIGS. 24A-D show a nozzle array formed according to embodiments of the present invention. The nozzle array includes, e.g., a 1×4 array (although it is understood that this may be scaled to any size n×m nozzles) of nozzles, as shown in FIG. 24B (line b in 24A). These nozzles are associated with wells, as shown in FIG. 24C (line c in 24A) having widths in the y direction greater than the widths of the nozzle tips. FIG. 24D shows a sectional view of the nozzle array (line d in 25A).

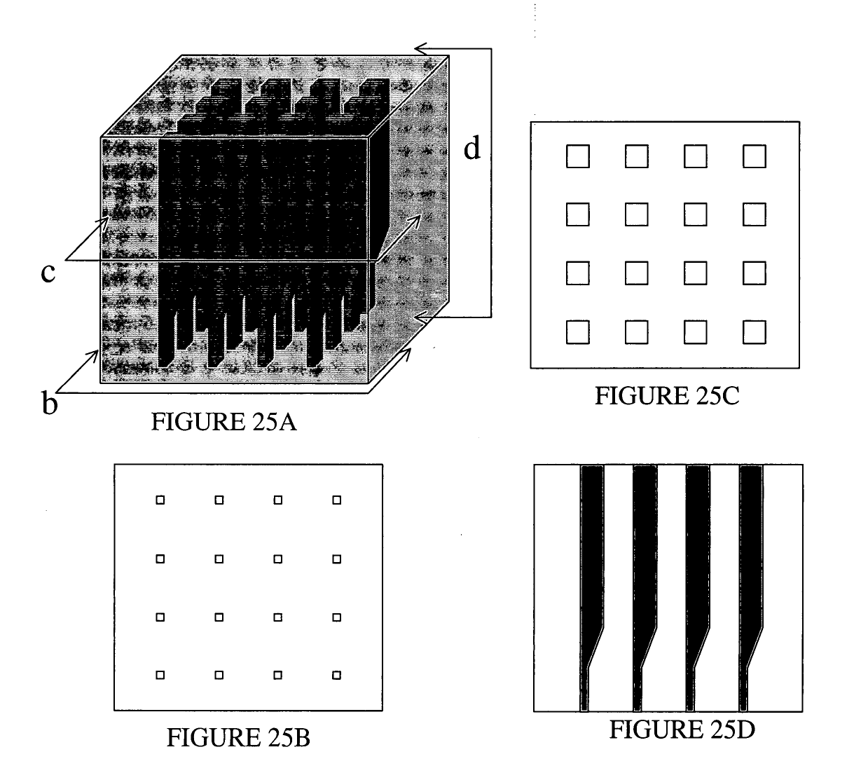

FIGS. 25A-D show a nozzle array formed according to embodiments of the present invention. The nozzle array includes, e.g., a 4×4 array (although it is understood that this may be scaled to any size n×m nozzles) of nozzles, as shown in FIG. 25B (line b in 25A). These nozzles are associated with wells, as shown in FIG. 25C (line c in 25A), wherein the wells are formed having approximately the same widths in the y direction as that of the nozzle. Further, several nozzles are formed in each layer in the y direction. FIG. 25D shows a sectional view of the nozzle array (line d in 25A).

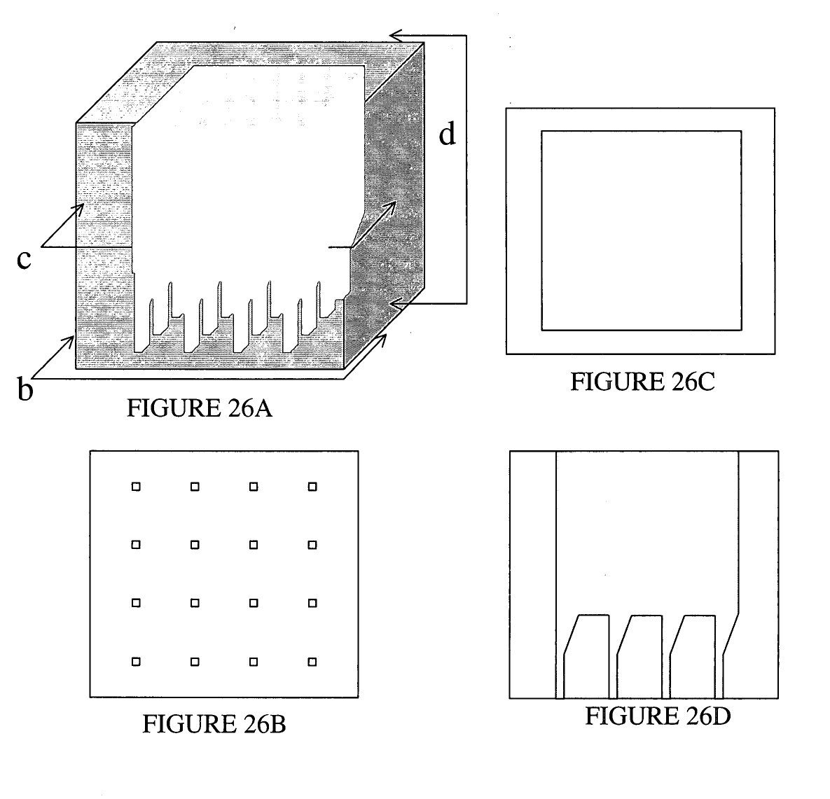

FIG. 26A shows a nozzle array formed according to embodiments of the present invention. The nozzle array includes, e.g., a 4×4 array (although it is understood that this may be scaled to any size n×m nozzles) of nozzles, as shown in FIG. 26B (line b in FIG. 26A). These nozzles are associated with a single well, as shown in FIG. 26C (line c in FIG. 26A). FIG. 26D shows a sectional view of the nozzle array (line d in FIG. 26A).

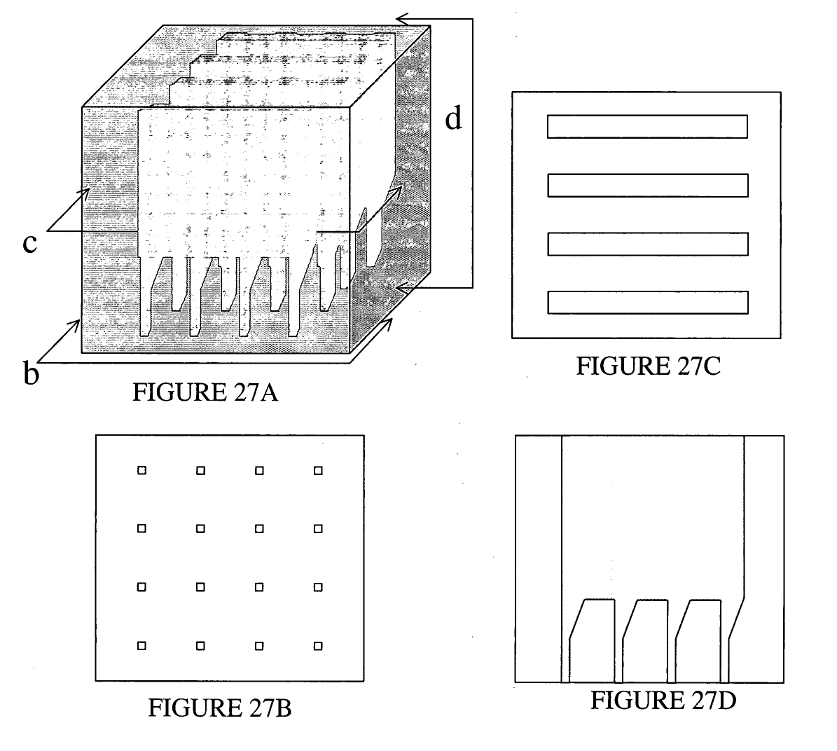

FIG. 27A shows a nozzle array formed according to embodiments of the present invention. The nozzle array includes, e.g., a 4×4 array (although it is understood that this may be scaled to any size n×m nozzles) of nozzles, as shown in FIG. 27B (line b in FIG. 27A). Plural nozzles are grouped with one well, forming 4 wells, each having 4 nozzles associated therewith, as shown in FIG. 27C (line c in FIG. 27A). FIG. 27D shows a sectional view of the nozzle array (line d in FIG. 27A).

### Applications

The herein described micro and nano nozzles may be used for various applications. For example, any known or future developed process that may employ “writing” techniques to deposit codes, conductors, patterns, devices, or any other material. These micro and nano nozzles may be used to build the soon to be ubiquitous nano-devices including electronic, mechanical, nano-fluidic, and many more.

Lithography

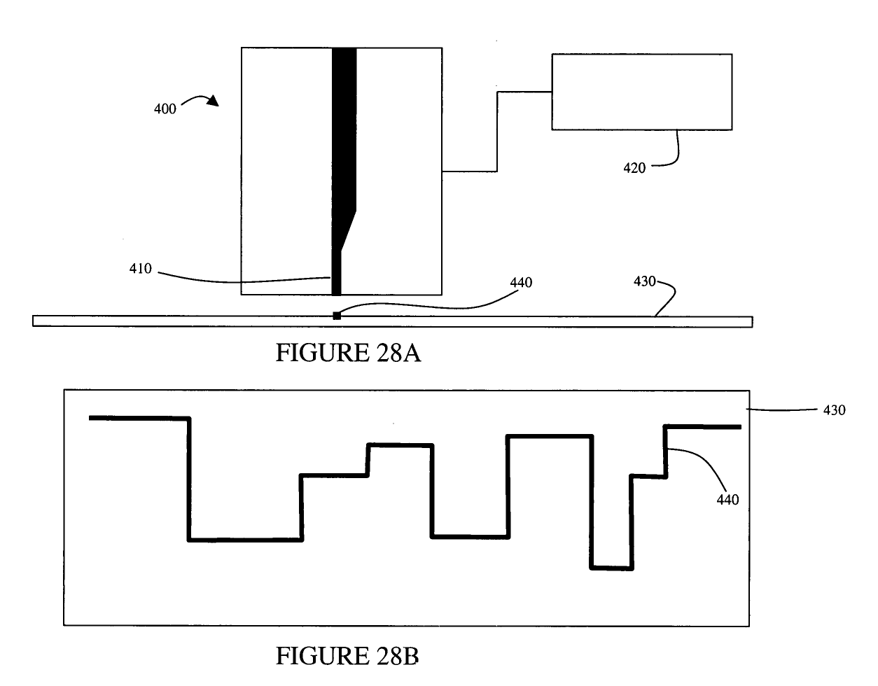

Any of the herein described nozzle systems may readily be employed for nanolithography. Referring now to FIGS. 28A-B, an embodiment of a nanolithography process is shown. A nozzle device 400 having a tip 410, e.g., manufactured according to one of the techniques described herein, is operably connected to a control system 420. A substrate 430 is shown onto which lithographic material 440 is deposited. The lithographic material is contained in the well of the nozzle (as described hereinabove), and is deposited under operation of the control system. For example, material may be deposited upon application of a field across electrodes formed as described above. Further, a pressure system may apply pressure to eject material 440 from the well of the nozzle device 400 through the tip 410. With a suitable X-Y motion controller (or in certain embodiments an X-Y-Z motion controller or a R, theta motion controller), any desired lithographic pattern 440 may be applied to the substrate 430.

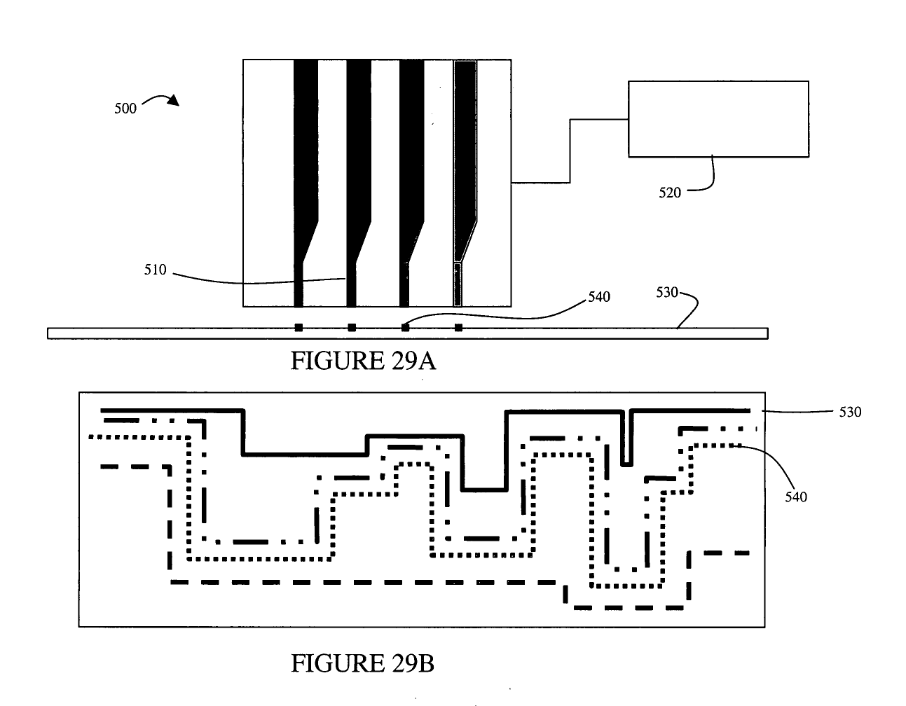

Referring now to FIGS. 29A-B, another embodiment of a nanolithography process is shown. A nozzle array 500 includes plural nozzle tips 510, manufactured as described herein, is operably connected to a control system 520. A substrate 530 is shown onto which plural lithographic material traces 540 are deposited. Note that while the traces 540 are shown as various types of dashed lines, it should be understood that this is to distinguish the various traces. These lines may be deposited as solid lines or in various patterns. The lithographic material is contained in the well of the nozzle, and is deposited under operation of the control system.

Both the system of FIGS. 28A-B and the system of FIGS. 29A-B may be employed to deposit various materials, such as ink, conductor traces, acids (e.g., as in etching operations), other materials to be nano-deposited on a substrate, and any combination comprising at least one of the foregoing. Note that the lithographic material may comprise microparticles or, in certain preferred embodiments, nanoparticles, for example, in a suitable suspension or solution.

Protein Sequencing

In certain embodiments of using the herein micro and nano nozzles, fast protein and DNA sequencing is attainable. The development of high-throughput DNA sequencers in the 90's have helped launched the genomic revolution of the 21st century. Almost on a monthly basis, one research group or another is announcing the complete sequencing of a biologically important organism. This has allowed researchers to cross reference species, finding shared and/or similar genes, and allowing the knowledge of molecular biologists in all the various fields to come together in a meaningful way. However, current techniques in DNA sequencing are far too tedious, tying up the valuable time of researchers. Even the fastest, most advanced DNA sequencers can at most process a few hundred thousand base pairs a day. The Human Genome Project took over 10 years to complete, indicating that current DNA sequencing technology still has a long way to go before it can be used as a diagnostic tool.

Using the herein nano-nozzles, a DNA sequencing method is presented that may sequence the entire Human Genome in a matter of minutes. Realizing and optimizing this technology opens new vistas for human endeavors, and enables practical applications that are nearly limitless. Culturing bacteria would be a thing of the past. Whenever faced with an unknown organism, not only could its exact species be determined immediately, but also its entire genotype, including new mutations or signs of genetic engineering. This process is based on utilization of the nanoscale nozzles and detection of ultra small and ultra fast signals. This may lead to the development of the ultimate sensor, not only for DNA, and RNA, but also to sequence denatured proteins (amino acid sequence of polypeptides).

Current DNA sequencing technology is most often based on electrophoresis and polymer chain reaction (PCR). PCR is used to create varying lengths of the DNA in question, which is then subjected to electrophoresis to resolve the size differences between the DNA fragments. However, this technique faces several bottlenecks. First, although PCR is useful in amplifying the amount of DNA material, it is time consuming, requires numerous reagents, including the use of an appropriate primer. Second, electrophoresis speed is dependent on the applied voltage. But the applied voltage cannot be further increased unless heat dissipation is similarly increased. Also, electrophoresis gel is only capable of resolving a small dynamic range (<500 bp). This requires splitting an organism's genome apart for sequencing and then re-assembling the pieces.

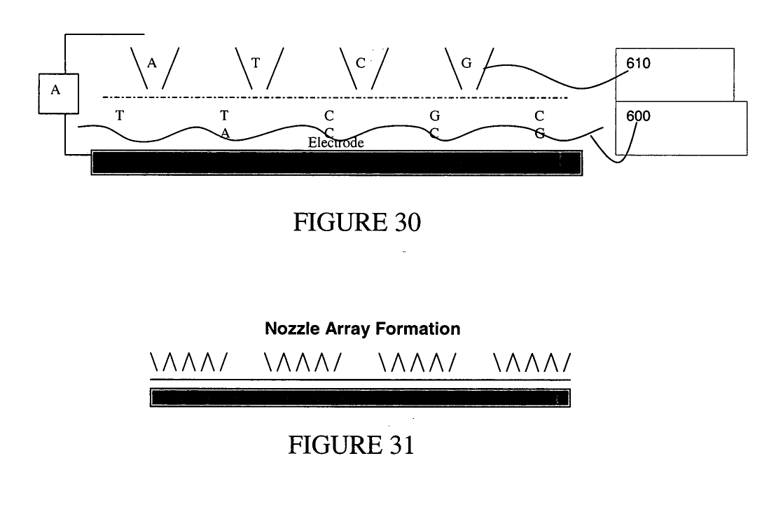

Instead of relying on electrophoresis to resolve the DNA sequence, the proposed sequencing technology is based on nano-electronics. Referring now to FIG. 30, the basic principle is described, wherein a DNA chain (or other protein) 600 is passed underneath four nano-sized nozzles 610 (or arrays of nozzles, e.g., as shown in FIG. 31). The four nozzles 610 are filled with adenine, cytosine, guanine, and thymine molecules respectively. Due to the complementary structures of adenine and thymine, and of guanine and cytosine, a hybridization event between nucleotides on the DNA chain and the nucleotides in the nozzle will occur when the correct pairs come into contact. This hybridization results in a lower energy state and charge transfer, which can be detected via an ammeter. This is because the conductivity between the nozzles and the electrode ground plate will be affected, thereby altering the current between the nozzle and the ground plate.

One important factor of this method is obtaining a sufficient signal to noise ratio. The system is preferably gated and synchronized such that the ammeter will only detect a signal when a nucleotide is directly below a nozzle. The bias applied may be positive, negative, or even alternating, as to maximize the change in conductivity. Cooling may be desirable to reduce the thermal noise. Alternatively, each DNA or protein strand may be passed under several arrays of nozzles, thereby averaging out the noise. FIG. 31 shows an exemplary array setup, e.g., that may average out noise and increase SNR. These features will help in assuring an excellent SNR.

However, if we assume a 10 picoamp current change under one applied volt, and 10 nanoseconds for detection, the signal is orders of magnitude larger than the thermal noise, even at room temperature. The sequencing speed would be enormous. Allowing 30 nanoseconds to move a nozzle from one nucleotide to the next (a speed of about 1 cm/sec), it would take only 40 nanoseconds to sequence one base pair, which is equivalent to 1.5 Billion base pairs a minute.

The above described DNA sequencing is enabled by creating a nozzle having tip dimensions on the order of about 5 Angstroms, for example, utilizing the above referenced and described nozzle manufacturing methods.

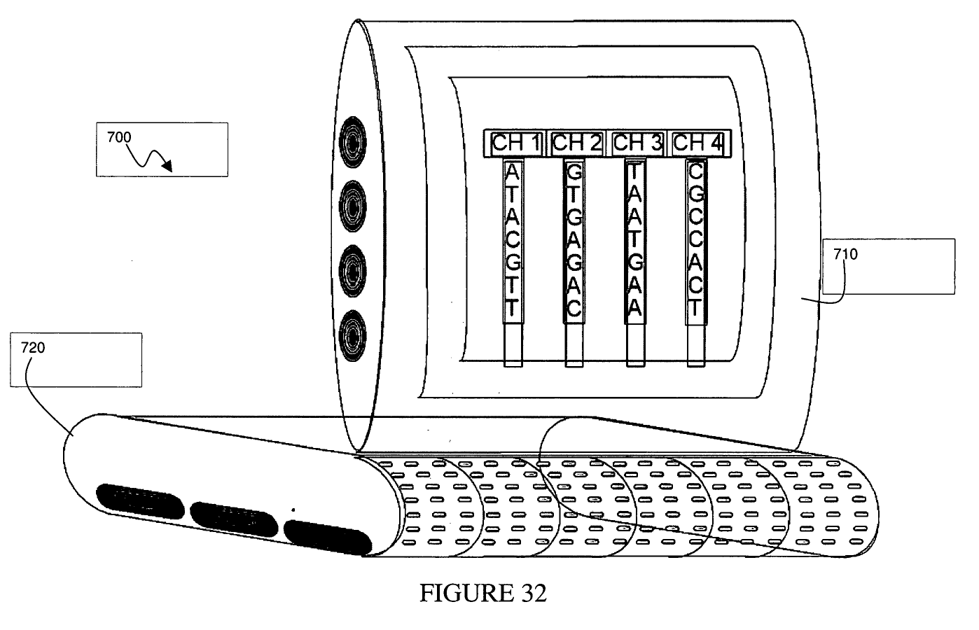

Referring now to FIG. 32, an embodiment of an ultra-fast DNA sequencing system 700 is shown. The sequencing system uses a nozzle array 710, as described herein. Further, the sequencing system uses a nano-metrology system 720 to precisely guide denatured DNA strands across the individual nozzles in the nozzle array.

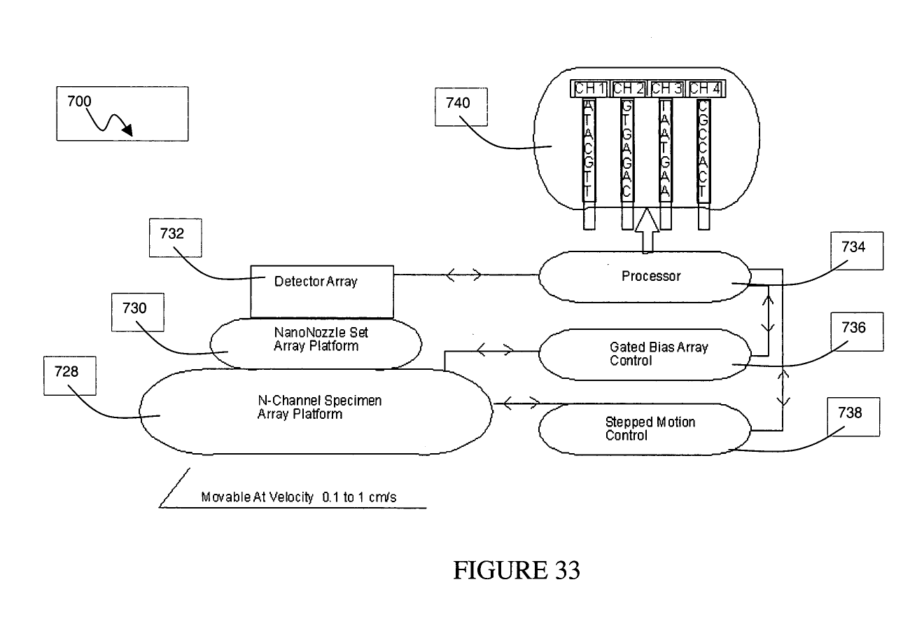

Referring now to FIG. 33, a schematic of major components of the ultra-fast DNA sequencing system 700 are shown. A nano-nozzle set array platform 730 upon an N-channel specimen array platform 728 is operably connected to a detector array 732 associated with a processor 734, generally for determining instances of hybridization events induced by the biases applied via a gated bias array control 736. The DNA specimens are maintained and displaced in relation to the array with a stepped motion control 738, which is also operably connected to the processor 734. The array platform 728 is movable at a velocity of about 0.1 to about 1 cm/s. Preferably, as shown, the motion is in a stepped manner, as described herein. The sequencing results are shown on a sequence display 740.

The stepped motion is important in preferred embodiments, as the motion and number of steps helps maintain knowledge of position on the ssDNA, and ultimately the position of hybridization events. The stepped motion may be from about 5% to about 100% of the nozzle opening dimension, preferably about 10% to about 25% of the nozzle opening dimension.

The gating is also important in preferred embodiments, as extremely synchronized current measurements, bias, motion steps, or other excitations are crucial to ultra-fast real time DNA sequencing.

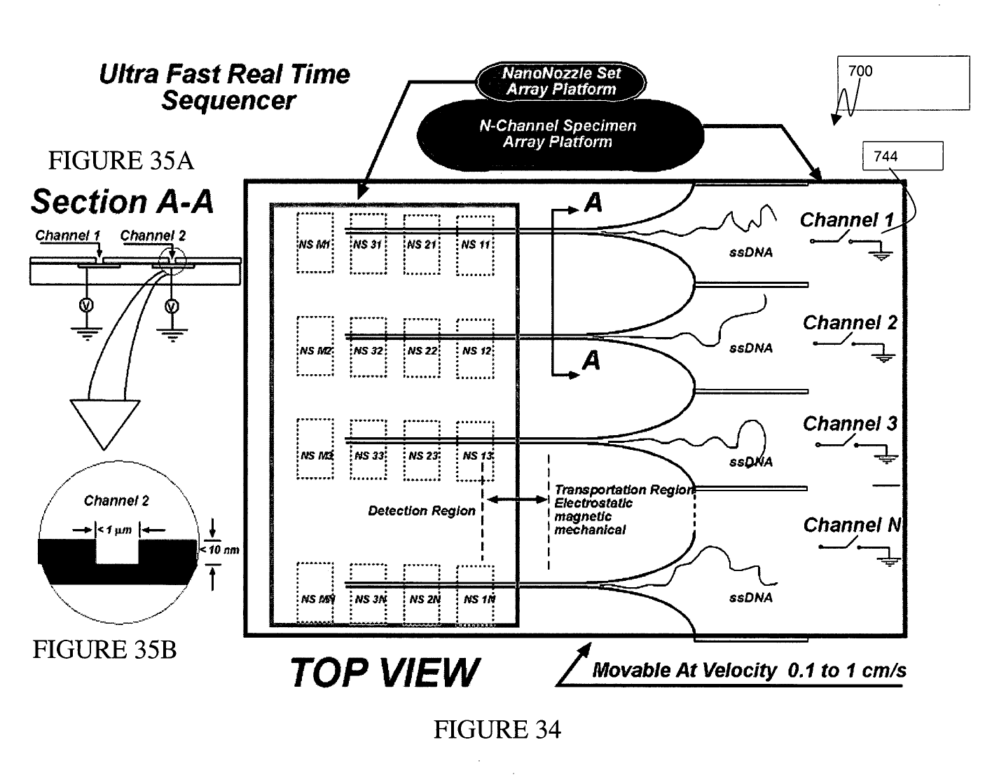

Referring now to FIG. 34, a top view of the ultra-fast DNA sequencing system 700 is shown. The DNA specimens are denatured and maintained within channels 744.

Referring now to FIGS. 35A-B (wherein FIG. 35A is a section along line A-A of FIG. 34), each channel 744 includes biasing systems for applying voltages across the DNA samples. As described in more detail herein, hybridization events induce measurable current variations across each of the nanonozzles within the nanonozzle set array platform. Preferably, the alignment between the nanonozzles and the channels is extremely precise.

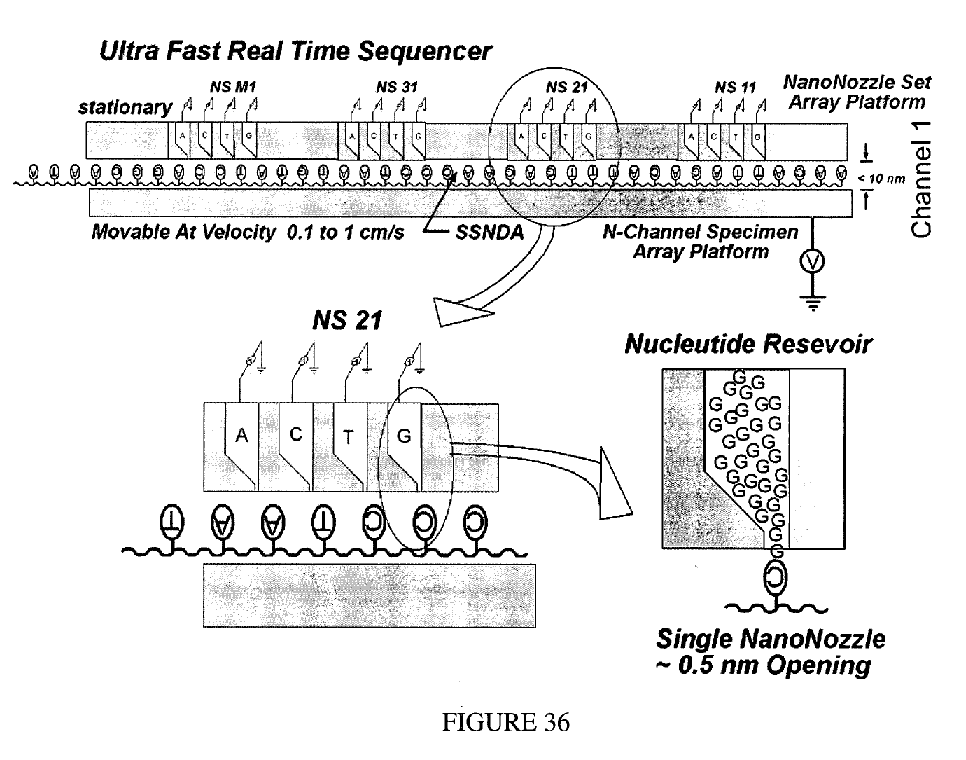

Referring now to FIG. 36, detailed section views of the sequencing process are shown. The nanonozzle set array platform includes nanonozzles with wells, or nucleotide reservoirs, of A,C,T and G molecules. The strands are moved along the channel and molecules from the nucleotide reservoirs interact with the molecules of the strand through the nozzle. These molecules hybridize with one other molecule (e.g., A with T, C with G) as is known in the art.

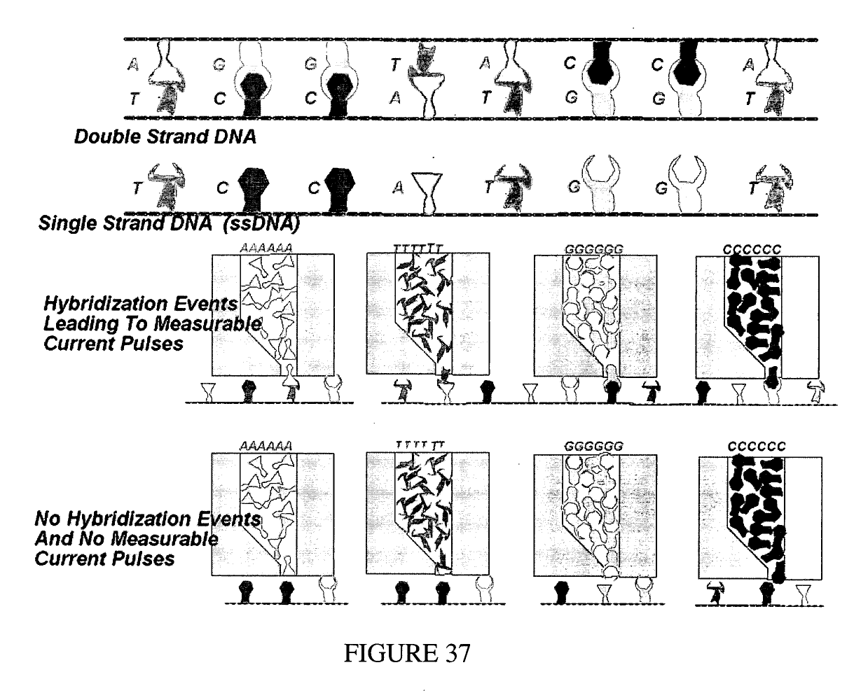

Referring now to FIG. 37, detailed views of hybridization events are shown. Only a hybridization event at the nanonozzle results in a measurable current pulse.

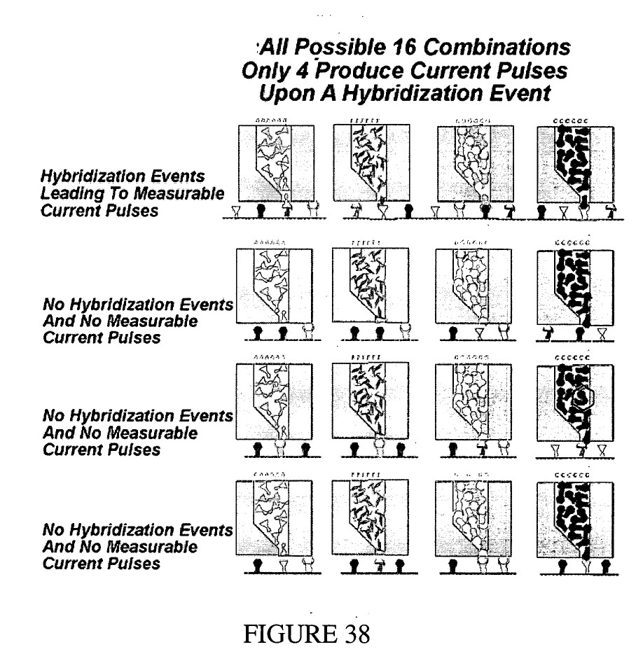

Referring now to FIG. 38, it is shown that, of all possible 16 combinations of A,T,G and C, only four produce current pulses upon a hybridization event.

As mentioned above, only a hybridization event produces a measurable (nanoseconds) current pulse at the nozzle. For proper operation, the following principles apply.
All excitation sources, detectors and stepped motion are synchronized.
Synchronized steps should be a fraction of the nozzle opening size (e.g., on the order of 5 nanometers).
Nozzle locations should be known with nanometer or sub-nanometer precision in relation to a known reference position.
Nanometer alignment is very important to optimal operation.
Vibrations and other agitations should be minimized.
A system is needed to measure very low amplitude nanosecond pulses.
For continuous real time measurement of millions, or even hundreds of millions, of base pairs, a wide dynamic range sub-nanometer stepper is preferred.
To calibrate the system, it is desirable to use known samples.

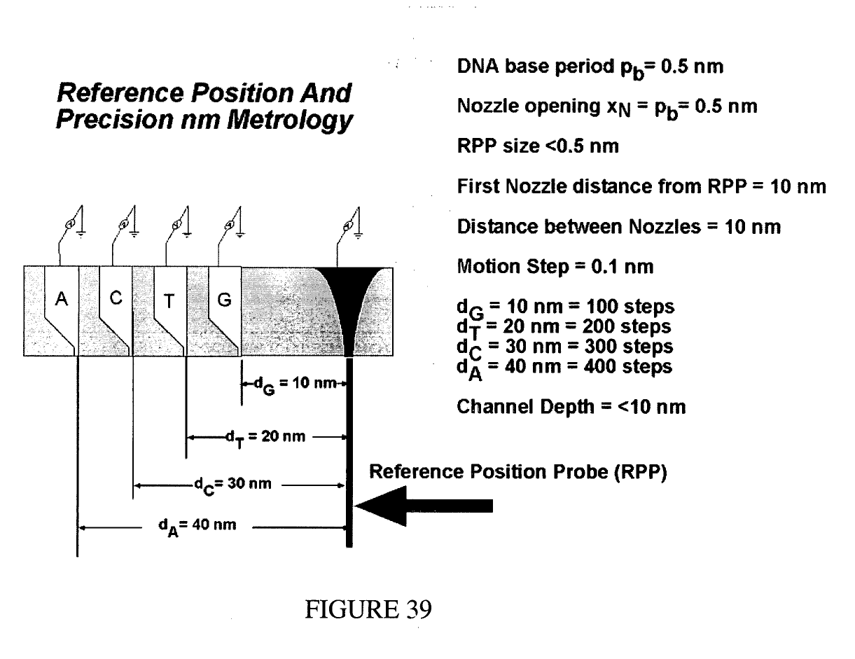

Referring now to FIG. 39, a reference position and precision nanometer metrology system is shown. A reference position probe (RPP), e.g., formed of platinum or other suitable material, or in the form of a nano-light guide, or other excitation means, is included in the nanonozzle array set. The positions of each nanonozzle relative the RPP is shown. This probe provides a spatial zero when sequencing commences.

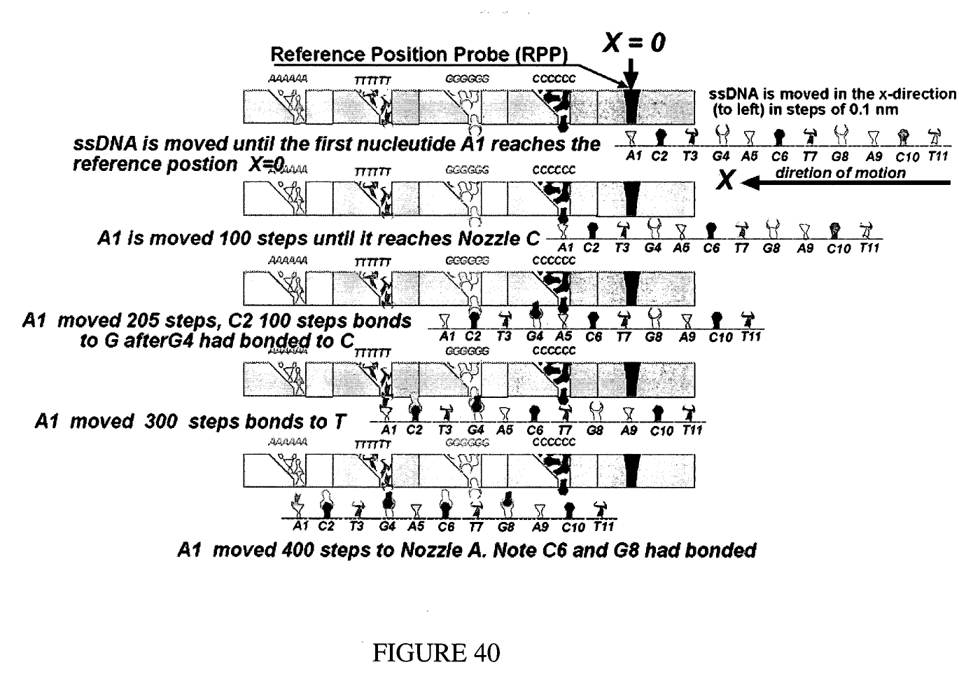

Referring now to FIG. 40, the stepped motion of ssDNA is shown relative to a known position of the RPP.

To assist the denaturing in conjunction with the precise stepwise motion, the DNA strand can be straightened bay various methods. In one embodiment, electrostatic fields may be used to attract the negatively charged strands. In another embodiment, a magnetically attractive bead may be applied to an end of the DNA strand, and the strand pulled with magnetic force. In a further embodiment, viscosity optimization may be employed, such that while dragging the strand through a liquid proximate or in the channel, it will straighten upon optimal dragging velocity and fluid viscosity conditions. Further, hydrophilicity may be used, e.g., by suitable material treatment at or in the nozzles and channel walls, to attract nucleotides. In other embodiment, hydrophobicity may be used, e.g., by suitable material at or in the nozzles and channel walls, to maintain the fluid within the channel.

Thus, as shown and described, the herein system including nano-nozzles and nano-nozzle arrays are very well suited for ultra fast real time DNA sequencing operations.

Chemical Synthesis and Analysis

As is apparent to those skilled in the art of nano-chemistry or micro-chemistry, the herein described nozzles may readily be utilized in systems for combining various materials for chemical reaction, or chemical detection and analysis. For example, the nozzle may dispense a chemical “A” that interacts in a known manner with a chemical “B” provided in sufficiently close range with the nozzle. As with the above described hybridization current changes, a measurable event occurs when A interacts with B. This measurement may be, e.g., a current change, inelastic tunneling conduction, or a wavelength shift.

Further, a probe may be incorporated in the nozzle system (preferably manufactured to known dimensional relationship with the array) to measure current change, inelastic tunneling conduction, or a wavelength shift.

Additionally, DNA synthesis may be enabled by using nano-nozzle arrays of the present invention.

While preferred embodiments have been shown and described, various modifications and substitutions may be made thereto without departing from the spirit and scope of the invention. Accordingly, it is to be understood that the present invention has been described by way of illustrations and not limitation.

1. A nozzle structure comprising:
a monolithic body having an array of nozzles, the nozzles having sectional openings having heights of about 100 nm or less,
the nozzles associated with a well structure.

2. The nozzle structure as in claim 1, wherein the nozzles have sectional openings having heights of about 50 nm or less.

3. The nozzle structure as in claim 1, wherein the nozzles have sectional openings having heights of about 20 nm or less.

4. A nozzle structure comprising:
a monolithic body having an array of nozzles, the nozzles having sectional openings having heights of about 100 nm or less,
each nozzle being associated with a well structure.

5. The nozzle structure as in claim 4, wherein the nozzles have sectional openings having heights of about 50 nm or less.

6. The nozzle structure as in claim 4, wherein the nozzles have sectional openings having heights of about 20 nm or less.

7. A method of producing a nozzle comprising:
processing a well on a layer supported by a substrate, the well having a recessed region and at least one sloped wall, the layer having a plateau region adjacent the well;
processing an etch removable layer at least at the plateau region;
removing the layer;
repeating the above steps at least one time to provide a plurality of layers each having a well therein;
aligning and stacking the layers;
cutting the stack of layers substantially at the plateau regions of the well to expose a cut edge; and
etching from the cut edge at least a portion of the etch removable layer at the plateau to create a nozzle tip.

8. The method as in claim 7, wherein the thickness of the etch removable layer defines a thickness dimension of the nozzle tip.

9. The method as in claim 7 further comprising:
grinding or polishing the cut edge of the stack to minimize the length of the plateau area prior to etching.

10. The method as in claim 7 wherein the well is substantially symmetrical, further comprising slicing through the recessed region of the well thereby providing a pair of structures to be cut in the area of the plateau.

11. The method according to claim 7 further comprising, prior to removing the layer, filling the recessed region of the well with a removable material.

12. The method as in claim 7, wherein a thickness of the etch removable layer defines a height dimension of the nozzle tip.

13. The method as in claim 12, wherein the thickness of the etch removable layer is about 100 nm or less.

14. The method as in claim 12, wherein the thickness of the etch removable layer is about 50 nm or less.

15. The method as in claim 12, wherein the thickness of the etch removable layer is about 20 nm or less.

16. The method according to claim 7, wherein the nozzle tip is a temporary nozzle opening, further comprising
filling the temporary nozzle opening to a defined width with a first material,
filling the region surrounding the first material with a second material, the first material being removable,
removing the first material,
wherein the second material is resistant to the removal of the first material, thereby creating a nozzle having the defined width, a height defined by the thickness of the etchable material and a length defined by a length of the plateau to the cut line.

17. A method of producing a nozzle comprising:
processing a plurality of wells on a layer of a wafer supported by a substrate, the wells each having a recessed region and at least one sloped wall, the layer having plateau regions adjacent each well;
processing an etch removable layer at least at the plateau regions;
removing the layer;
repeating the above steps at least one time to provide a plurality of layers each having wells therein;
aligning and stacking the layers;
cutting the stack of layers substantially at the plateau regions of the wells to expose a cut edge; and
etching from the cut edges at least a portion of the etch removable layer at the plateau to create nozzle tips.

18. A method of producing a nozzle comprising:
providing a device layer selectively bonded to a substrate layer with areas of strong bonding and areas of weak bonding;
processing one or more wells in the areas of weak bonding in the device layer wherein the wells have recessed regions and plateau regions;
processing an etch removable layer at least in the plateau regions of the well;
removing the device layer by debonding the strong bond areas and minimally or not at all damaging the weak bond areas;
repeating the above steps at least one time to provide a plurality of device layers having at least one well therein;
aligning the plurality of device layers;
stacking the device layers;
cutting the stack of device layers normal to the surface of the device layers at the plateau regions of the well; and
etching from the cut edge the etch removable layer at the plateau to create a nozzle tip.

19. A method of producing a nozzle comprising:
processing a well on a layer supported by a substrate, the wells having a recessed region and at least one sloped wall, the layer having a plateau region adjacent the well;
processing an etch removable layer at least at the plateau region;
removing the layer;
stacking a cover layer on the layer having the well;
cutting the stack substantially at the plateau region of the well to expose a cut edge; and
etching from the cut edge at least a portion of the etch removable layer at the plateau to create a nozzle tip.

20. A method of producing a nozzle comprising:
processing a well through multiple known thickness layers, the multiple known thickness layers supported by a substrate, the wells having a recessed region and at least one sloped wall, a top layer of the multiple known layers having a plateau region adjacent the well;
processing an etch removable layer at least at the plateau region;
removing the layer;
stacking a cover layer on the layer having the well;
cutting the stack substantially at the plateau region of the well to expose a cut edge; and
etching from the cut edge at least a portion of the etch removable layer at the plateau to create a nozzle tip,
wherein the known multiple layers provide metrics functionality.

21. A method of detecting a first molecule comprising:
providing a nozzle within a monolithic body having an opening dimension of about 100 nm or less and a nozzle well and an associated electrode;
incorporating a quantity of a second molecule in the nozzle well, the second molecule selected to have known energy state interaction with the first molecule;
providing an electrode associated with the first molecule;
whereby the known energy state is detectable by a potential across the electrodes when the first molecule to be detected and the second molecules are in molecular interaction range.

22. The method as in claim 21, wherein the nozzle has an opening dimension of about 50 nm or less.

23. The method as in claim 21, wherein the nozzle has an opening dimension of about 20 nm or less.

24. A method of sequencing a DNA strand comprising:
providing a nozzle array within a monolithic body, the nozzle array including at least four nozzles, each nozzle having an opening dimension of about 100 nm or less, associated nozzle well and an associated electrode;
providing adenine, cytosine, guanine, and thymine molecules within each of the four nozzle wells;
providing an electrode associated with the DNA strand;
passing a DNA strand under the nozzles; and
detecting across the electrodes hybridization events characterized by a relatively lower energy state when complementary structures of adenine and thymine, and of guanine and cytosine are in molecular interaction range.

25. The method as in claim 24, wherein the nozzle has an opening dimension of about 50 nm or less.

26. The method as in claim 24, wherein the nozzle has an opening dimension of about 20 nm or less.

27. A method of sequencing a DNA strand comprising:
providing a nozzle array within a monolithic body, the nozzle array including at least four nozzles, each nozzle having an opening dimension of about 100 nm or less, associated nozzle well and an associated electrode;
the nozzles filled with adenine, cytosine, guanine, and thymine molecules respectively;
providing an electrode associated with the DNA strand;
providing a reference position probe;
passing a DNA strand under the reference position probe and the nozzles; and
detecting across the electrodes hybridization events characterized by a relatively lower energy state when complementary structures of adenine and thymine, and of guanine and cytosine are in molecular interaction range.

28. The method as in claim 27, wherein the nozzle has an opening dimension of about 50 nm or less.

29. The method as in claim 27, wherein the nozzle has an opening dimension of about 20 nm or less.

30. A method of sequencing a DNA strand comprising:
providing a nozzle array within a monolithic body, the nozzle array including at least four nozzles, each nozzle having an opening dimension of about 100 nm or less, associated nozzle well and an associated electrode;
the nozzles filled with adenine, cytosine, guanine, and thymine molecules respectively;
providing an electrode associated with the DNA strand;
providing a movable platform for holding the DNA strand;
moving the DNA strand under the nozzles by motion of the movable platform; and
detecting a hybridization event characterized by a relatively lower energy state when complementary structures of adenine and thymine, and of guanine and cytosine are in molecular interaction range.

31. The method as in claim 30, wherein the motion is stepped motion.

32. The method as in claim 31, wherein the stepped motion is in steps of about 0.5 to about 5 nanometer distances.

33. The method as in claim 30, wherein the nozzle has an opening dimension of about 50 nm or less.

34. The method as in claim 30, wherein the nozzle has an opening dimension of about 20 nm or less.

35. A method of nanolithography comprising:
providing a nozzle structure including a monolithic body having an array of nozzles, the nozzles having openings with sectional openings having heights of about 100 nm or less, the nozzles associated with a well structure;
providing lithographic material in the well structure; and
dispensing said lithographic material through said nozzle.
